(19) United States
(12) Patent Application Publication
(10) Pub. No.: US 2026/0104877 A1
(43) Pub. Date: Apr. 16, 2026

(54) UPDATING CONTAINER GROUPS EXECUTING IN A PRODUCTION ENVIRONMENT

(71) Applicant: INTERNATIONAL BUSINESS MACHINES CORPORATION, ARMONK, NY (US)

(72) Inventors: Yue Wang, Beijing (CN); Jing Jing Wei, Beijing (CN); Yang Kang, Beijing (CN); JIA LIN WANG, BEIJING (CN); Yi Fan Wu, Beijing (CN)

(21) Appl. No.: 18/911,735

(22) Filed: Oct. 10, 2024

(51) Int. Cl. G06F 8/65

(52) U.S. Cl. CPC G06F 8/65

(57) ABSTRACT

Techniques for updating container groups executing in a production environment include receiving a command to update a container group that includes one or more containers. The techniques further include determining that a transaction between the container group and an external service has not yet completed. The techniques further include initiating an in-place update operation that retains the container group and replaces the one or more containers included in the container group with one or more updated containers using an updated container image. The techniques further include, responsive to receiving a callback of the transaction between the container group and the external service, storing information returned by the callback in memory, and responsive to a determination that the in-place update operation has completed, providing the information stored in memory to the container group that includes the one or more updated containers.

### BACKGROUND

The present disclosure relates to container orchestration, and, more specifically, to updating application container groups.

Application containers are used for building, packaging, and deploying software. In the simplest terms, an application container includes both application code and the dependencies that the application code needs to execute properly. Multiple application containers (also called containerized workloads or containerized applications) can execute on the same machine and share an operating system (OS) kernel with other application containers, each running as isolated processes in a user space. Container orchestration is the automation of operational tasks needed to run containerized workloads or applications and services. These operational tasks include management of a container's lifecycle, such as application container provisioning, deployment, scaling (up and down), networking, and load balancing.

### SUMMARY

Aspects of the present disclosure are directed toward a computer-implemented method comprising receiving a command to update a container group, where the container group includes one or more containers that share storage and network resources, and the one or more containers comprise executable units of software that package application code with libraries and dependencies for the application code. The computer-implemented method further comprises determining that a transaction between the container group and an external service has not completed. The computer-implemented method further comprises initiating an in-place update operation that retains the container group and replaces the one or more containers included in the container group with one or more updated containers using an updated container image. The computer-implemented method further comprises, responsive to receiving a callback of the transaction between the container group and the external service, storing information returned by the callback in memory. The computer-implemented method further comprises, responsive to a determination that the in-place update operation has completed, providing the information stored in memory to the container group that includes the one or more updated containers.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example computational environment that implements techniques for updating a service implemented by one or more container groups operating in a production environment, in accordance with some embodiments of the present disclosure.

FIG. 2 is a diagram that illustrates aspects of updating a service implemented by container groups using a recreate update procedure and an in-place update procedure based on a status of a transaction between a container group and an external service, in accordance with some embodiments of the present disclosure.

FIG. 3 is a diagram that illustrates aspects of a recreate update operation, in accordance with some embodiments of the present disclosure.

FIG. 4 is a diagram that illustrates aspects of an in-place update operation, in accordance with some embodiments of the present disclosure.

FIG. 5 is a diagram that illustrates aspects of a recreate update operation that is performed after the in-place update operation shown in FIG. 4, in accordance with some embodiments of the present disclosure.

FIG. 6 is a flow diagram illustrating an example method for updating container groups executing in a production environment, in accordance with some embodiments of the present disclosure.

FIG. 7 is a flow diagram illustrating an example method for recreating a container group after a determination that an in-place update operation and a transaction that was initiated prior to receiving an update command has completed, in accordance with some embodiments of the present disclosure.

FIG. 8 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward updating container groups executing in a production environment. While not limited to such applications, embodiments of the present disclosure may be better understood in light of the following context.

The implementation of cloud architectures has resulted in significant improvements to the efficiency of computer operations. By running many different applications in many different contexts, a cloud architecture can help maximize the utilization computing resource capabilities. One common component of modern cloud architectures is containers. A container is a software package that contains the software components needed for executing an application. This includes the executable program as well as system tools, libraries, and settings. Containers provide developers with the ability to create predictable environments that are isolated from other applications. Containers can also include software dependencies needed by the executable program, such as specific versions of programming language runtimes and other software libraries.

A container-orchestration system can be used to automate cloud-native application deployment, scaling, and management using containers. Kubernetes® is one example of an open source container-orchestration system. The Kubernetes® container-orchestration system defines an architecture of clusters and pods for running cloud-native applications using containers. A cluster is a set of node machines (also “compute machines” or “nodes”) for running containerized applications (cloud-native applications executed using containers). A pod is the smallest deployable computing unit (an object that has a state, associated operations, and can be accessed by an identifier), where the pod is a grouping of one or more containers that operate together. As used herein, the term “container group” is synonymous with the Kubernetes® pod.

A container group resides on a node, and more than one container group can share the same node in a cluster. The containers within each container group share common networking and storage resources from a host node, as well as specifications that determine how the containers execute. Although a container group can encapsulate many containers, often each container group has only one container or a small number of tightly integrated containers. The contents of a container group are scheduled and located together, modeling an application-specific logical host. The shared context of a container group is set by facets of isolation, such as Linux® namespaces or control groups (cgroups).

Cloud-native automation is the use of automated processes and tools to manage aspects of cloud-native applications and/or services, which include container orchestrators like Kubernetes® and OpenKruise™. In particular, cloud-native automation can be used to update a container included in a container group that runs a cloud-native application in a production environment. A production environment, or a deployment environment, comprises a computational environment in which a current version (e.g., the most recent version) of software or a product is made accessible to end-users, and a container executing in the production environment can be updated by deleting the currently executing container and creating a new container using a container image that includes updated executable code. As described herein, cloud-native automation utilizes a recreate update operation and/or an in-place update operation to update a container included in a container group.

The recreate update operation deletes a current container group (including an assigned storage mount, which, in the context of Kubernetes®, is a PersistentVolumeClaim (PVC)), and thereafter creates a new container group using a container image that includes updated executable code. However, performing the recreate update operation can lead to downtime of an application implemented by the container group because the application will be unavailable until the new container group is up and running, which can lead to a timeout of a transaction between the application and an external service (e.g., a third-party service) that was initiated before preforming the recreate update operation. Also, performing the recreate update operation does not preserve the unique identifier (UID) of the current container group and deletes the current storage mount. As such, information for completing a transaction between the application and an external service that was initiated prior to preforming the recreate update operation will be lost and the transaction will fail.

The in-place update operation updates a container(s) included in a container group without deleting the container group (i.e., the container group object). That is, the in-place update operation deletes the container(s) included in the container group and creates a new container(s) using a container image that includes updated executable code. This provides for a faster update process as compared to the recreate update operation and can be used in conjunction with the aspects of the present disclosure to allow a transaction, which was initiated prior to receiving an update command, to be completed by holding a callback in memory and providing the callback to the container group after completion of the in-place update operation. However, performing the in-place update operation retains the container group (i.e., the container group object) on the original node and keeps the same container group resource configuration, which can lead to resource allocation issues, such as load balancing issues.

Advantageously, aspects of the present disclosure overcome the challenges above by performing an in-place update operation when a transaction with an external service is incomplete, and thereafter, performing a recreate update operation after the transaction with the external service has completed. As such, the transaction with the external service is allowed to finish, and thereafter, a container group resource configuration for the container group can be updated. More specifically, aspects of the present disclosure receive a command to update a container group, and in response, determine that a transaction between the container group and an external service is incomplete (e.g., there is an outstanding request to the external service). Based on the incomplete transaction, aspects of the present disclosure execute an in-place update operation that deletes one or more containers in the container group without deleting the container group itself, and creates one or more updated containers in the container group using an updated container image. In the event that a callback of the transaction between the container group and the external service is received prior to the in-place update operation completing, the callback (e.g., information returned by the external service) can be stored, and the callback can be provided to the container group after the in-place update operation has completed.

Moreover, in order to avoid resource allocation issues associated with performing the in-place update operation, aspects of the present disclosure perform the recreate update operation that deletes the container group and creates a new container group using the updated container image upon a determination that both the in-place update operation and the transaction between the container group and the external service have completed. As used herein, the term “update” refers to both an update comprising a minor software release, as well as an upgrade comprising a major software release.

Accordingly, the techniques for updating application container groups described herein are an improvement in the technical field of container orchestration generally, and more particularly, to the technical field of cloud-native automation that provides services to end-users during a service upgrade without failed transactions, such that service disruptions during the service upgrade are avoided or mitigated. These advantages, as well as other advantages of the present disclosure, are described below.

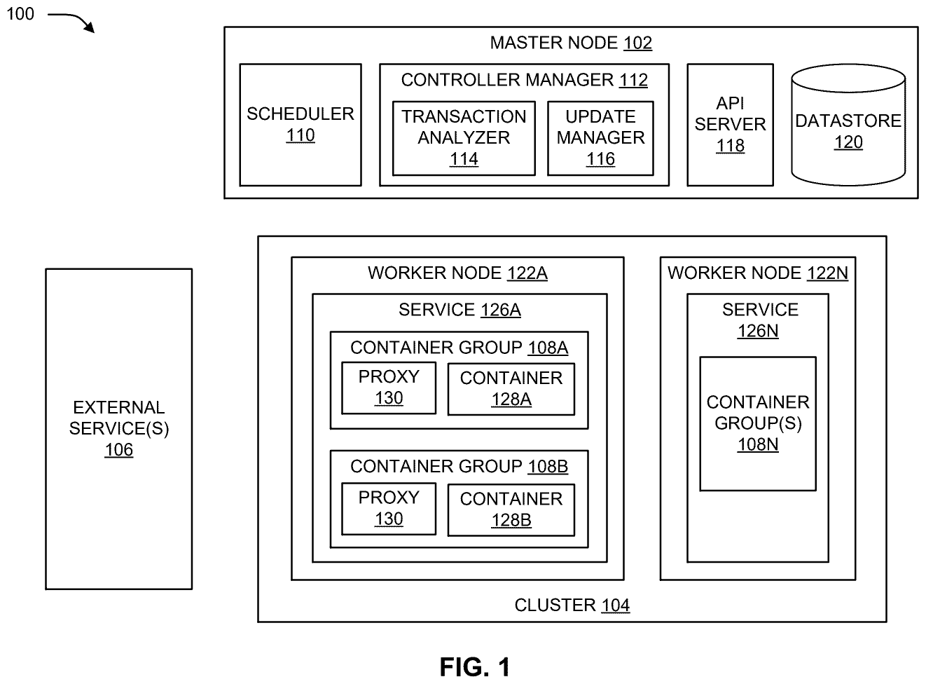

Referring now to the figures, FIG. 1 illustrates a block diagram of an example computational environment 100 that can implement updating of a service implemented by one or more container groups operating in a production environment, in accordance with some embodiments of the present disclosure. The example computational environment 100 includes components of a container-orchestration platform. The container-orchestration platform is designed to manage and automate the configuration, deployment, and operation of components in the computational environment 100. In some embodiments, the container-orchestration platform can be implemented using the Kubernetes® container-orchestration platform.

The components of the container-orchestration platform can include master node 102 that operates as a control plane for cluster 104 that hosts worker nodes 122A and 122N (collectively 122, where N can refer to any positive integer representing any number of worker nodes). Master node 102 and worker nodes 122 comprise physical or virtual machines. Cluster 104 can host services 126A and 126N (collectively 126, where N can refer to any positive integer representing any number of services), which can include software programs, applications, websites, and the like. Services 126 can be implemented by one or more container groups 108A, 108B, 108N (collectively 108, where N can refer to any positive integer representing any number of container groups), which in some embodiments, can comprise Kubernetes® pods. Container group 108 is a deployable computing unit represented as an object that has a state, associated operations, and an identifier. The containers 128 included in a container group 108 share common networking and storage resources from a respective worker node 122, as well as specifications that determine how container executes. Container groups 108 are configured to communicate with one or more external services 106 for various purposes, including transactions that included callbacks. External services 106 can comprise any type of service that is accessible outside of cluster 104 (e.g., via an external Internet Protocol (IP) address). Illustratively, an external service 106 can include user authentication services, encryption services, and other services.

Master node 102 hosts components of a control plane for managing cluster operations such as scheduling, resource allocation, and maintaining the state of containerized applications. In the example illustrated, the control plane includes: scheduler 110 for scheduling resources of the worker nodes 122 to container groups 108; application programming interface (API) server 118 that exposes a Hypertext Transfer Protocol (HTTP) API that enables users, clusters (e.g., cluster 104), and external components (e.g., external service 106) to communicate with each other; controller manager 112 that monitors the state of cluster 104 and makes changes to maintain applications running on cluster 104; datastore 120 (e.g., a distributed, open-source key-value store) for cluster 104 to store and manage critical information, such as configuration data, state data, and metadata for the container-orchestration platform; and other components as will be appreciated by persons of ordinary skill.

In this illustrative example, controller manager 112 includes update manager 116 and transaction analyzer 114. Update manager 116 updates services 126 hosted on cluster 104 by updating the container groups 108 that implement a service 126 using the recreate update operation and/or the in-place update operation.

Transaction analyzer 114 monitors transactions between container groups 108 and external services 106 and assigns an in-place update tag to container groups 108 that have an ongoing (incomplete) transaction with external service 106. As will be described below, the in-place update tag determines which of the recreate update operation and the in-place update operation is to be performed.

The recreate update operation deletes a current container group (i.e., a container group object, associated container(s), and storage mount) and creates a replacement container group and associated container(s) using an updated container image (i.e., a static file comprising updated executable code and binary data that encapsulates an application and its software dependencies). As described earlier, during a time that the recreate update operation is being performed, a service provided by container group being replaced will be unavailable until a new container group is up and running, resulting in the service being unavailable to end-users. This can lead to a timeout of a transaction between the service and an external service that was initiated prior to initiating the recreate update operation. Also, performing the recreate update operation does not preserve a unique identifier (UID) of a current container group and deletes a storage mount assigned to the container group. As such, information for completing a transaction between the service and the external service initiated prior to preforming the recreate update operation will be lost and the transaction will fail.

The in-place update operation keeps (does not delete) a current container group (i.e., a current container group object) and replaces the container(s) that are included in the current container group with a new container(s) using an updated container image. The in-place update operation provides for a faster update process as compared to the recreate update operation because the container group object is not deleted. Also, because the in-place update operation does not delete the current container group, an ongoing transaction between the container group and an external service can be completed using proxy, as will be described below.

Returning to FIG. 1, transaction analyzer 114 monitors transactions between container groups 108 and external services 106 and assigns an in-place update tag (or flag) to container groups 108 that have an ongoing (incomplete) transaction with external service 106. The in-place update tag can comprise a keyword, label, or other indicator that is added to metadata for the container group 108, which can be stored in datastore 120. In some embodiments, transaction analyzer 114 continuously monitors container groups 108 executing on cluster 104 for ongoing transactions. In other embodiments, responsive to a command to update service 126, transaction analyzer 114 is triggered to determine whether any of the container groups 108 of a service 126 have ongoing transactions with an external service 106. A transaction can comprise any type of interaction between a container group 108 and external service 106 in which information is provided back to the container group 108. Illustratively, a service 126 implemented by one or more container groups 108 can, in some embodiments, perform a callback function, wherein a function is passed as an argument to another function performed by external service 106, which then performs the function and returns the results to a respective container group 108 using a synchronous or asynchronous technique.

In some embodiments, transaction analyzer 114 monitors transaction logs of container groups 108 to identify incomplete transactions and assigns the in-place update tag to a container group 108 identified as having an incomplete transaction. The in-place update tag indicates to update manager 116 that, in the event that an update command is received, perform the in-place update operation. After assigning the in-place update tag to a container group 108, transaction analyzer 114 continues to monitor the transaction log for an indication that the transaction has completed, whereupon transaction analyzer 114 removes the in-place update tag from the container group 108. As an illustration, transaction analyzer 114 can perform keyword searches (e.g., periodically or continuously) of a transaction log of a container group 108 for a keyword that indicates that the container group 108 is waiting to receive a callback from an external service 106, and transaction analyzer 114 can assign the in-place update tag to the container group 108 when the keyword is identified. Assignment of the in-place update tag to a container group 108 by transaction analyzer 114 indicates to update manager 116 that the container group 108 is associated with an incomplete transaction (e.g., the container group 108 is waiting for a callback from external service 106). After assigning the in-place update tag, transaction analyzer 114 can perform keyword searches (e.g., periodically or continuously) of the transaction log for a keyword that indicates that the container group 108 received the callback from the external service 106, and transaction analyzer 114 can remove the in-place update tag from the container group 108 (e.g., remove the in-place update tag from metadata for the container group 108) when the keyword is identified.

Update manager 116 receives update commands from system administrators and/or other appropriate users. An update command specifies a service 126 to update using a container image that includes updated (a new version of) application code. Responsive to receiving an update command, update manager 116 determines, for each container group 108 in a service 126, whether a container group 108 is associated with an incomplete transaction with an external service 106. Update manager 116 determines whether a container group 108 is associated with an incomplete transaction by querying metadata for the container group 108 (located in datastore 120) for the existence of the in-place update tag. The existence of the in-place update tag assigned to a container group 108 indicates to update manager 116 to perform the in-place update operation. The absence of the in-place update tag assigned to a container group 108 indicates to update manager 116 to perform the recreate update operation.

Accordingly, in the case that a container group 108 is not assigned the in-place update tag, update manager 116 initiates performance of the recreate update operation, which deletes the current container group and container(s) included in the container group, and creates a replacement container group and new container(s) using an updated container image. In the case that a container group 108 is assigned the in-place update tag, update manager 116 initiates performance of the in-place update operation, which retains the current container group and replaces the container(s) included in the container group with a new container(s) using an updated container image. The in-place update operation allows for the completion of an ongoing transaction between the container group 108 and an external service 106 via a proxy 130, which is included in the container group 108.

Proxy 130 acts as an intermediary between the container(s) 128 in a container group 108 and an external service(s) 106. Network communications associated with transactions between a container group 108 and an external service 106 are routed through proxy 130. As an example, when requesting a callback function, a container group 108 provides the request to proxy 130, and in response, proxy 130 forwards the request to the intended external service 106. After performing the function, the external service 106 sends a callback to proxy 130, and proxy 130 forwards the information in the callback to the container group 108.

Proxy 130 is further configured to hold a callback of a transaction in computer memory during a time that a container associated with the transaction is replaced using the in-place update operation, and forward the callback to a new container created by the in-place update operation after the completion of the in-place update operation. Update manager 116, as part of initiating performance of the in-place update operation, instructs proxy 130 to hold the callbacks of any incomplete transactions received from an external service 106 during performance of in-place update operation. In the case that proxy 130 receives a callback from an external service 106 during a time that the in-place update operation is being performed, proxy 130 holds the callback (i.e., the information returned by the external service 106) in computer memory. When the in-place update operation completes, update manager 116 removes the hold on proxy 130 (e.g., via an instruction to the proxy) and proxy 130 forwards the callback to a new container created by the in-place update operation.

Accordingly, proxy 130 enables transactions initiated prior to an update of a container group 108 using the in-place update operation to be completed. However, as described previously, performing the in-place update operation keeps a container group 108 on an original worker node 122 node and keeps the same container group resource configuration, which can lead to resource allocation issues, such as load balancing issues. As referred to herein, resource allocation in container orchestration involves managing the distribution of compute resources like CPU, memory, and storage among containers within a cluster.

In some embodiments, update manager 116 is configured to avoid the resource allocation issues associated with the in-place update operation by performing the recreate update operation after determining that both the in-place update operation and any transactions between a container group 108 and an external service 106 have completed. As a non-limiting example, update manager 116 can monitor performance of an in-place update operation to detect when the in-place update operation completes. Because the update manager 116 is a component of controller manager 112, update manager 116 has access to state information of cluster 104 which enables update manager 116 to determine when the in-place update operation is complete.

After determining that the in-place update operation is complete, update manager 116 then determines whether a transaction between container group 108 and external service 106 that was ongoing at the time the in-place update operation was initiated has completed. If the transaction has not completed, update manager 116 monitors the container group 108 to detect when the transaction completes. The monitoring of the incomplete transaction can be performed by monitoring metadata for the container group 108 (stored in datastore 120) for the removal of the in-place update tag. As mentioned earlier, transaction analyzer 114 removes the in-place update tag from a container group 108 when transaction analyzer 114 detects that the transaction has completed. After determining that both the in-place update operation and the transaction have completed, update manager 116 initiates the recreate update operation to delete the container group 108 and container(s) 128 and create a replacement container group and respective container(s), thereby allowing controller manager 112 to perform resource allocation.

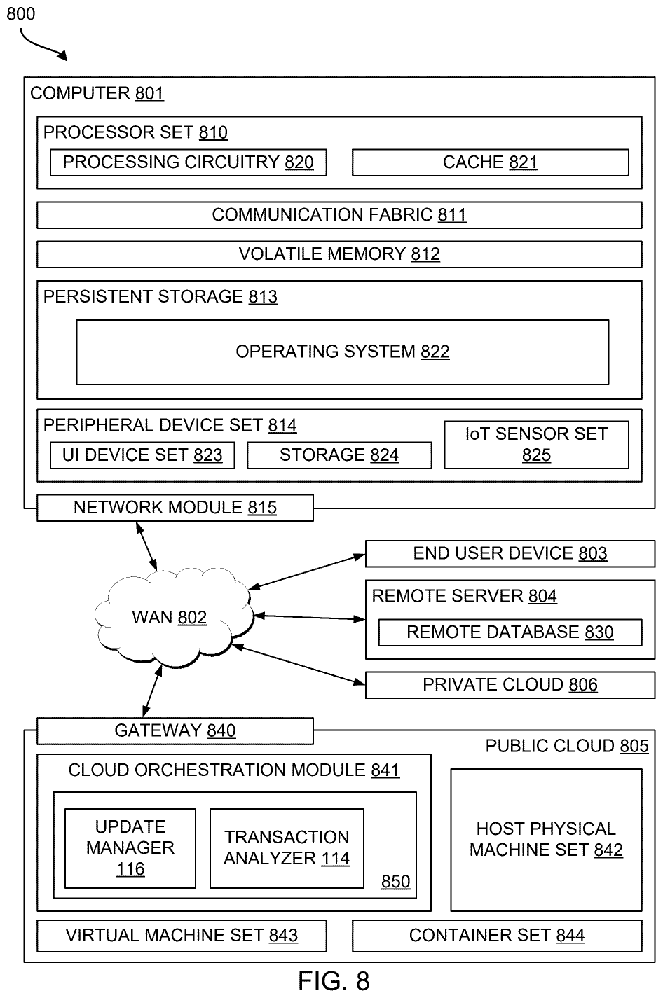

All or a portion of the computational environment 100 shown in FIG. 1 can be implemented, for example by all or a subset of the computing environment 800 of FIG. 8. The components in computational environment 100 can be implemented in software, hardware, firmware or a combination thereof. When software is used, the operations performed by the components can be implemented in program instructions configured to run on hardware, such as a processor unit. In some embodiments, the program instructions can be implemented in modules. Generally, modules (also referred to as program modules) include routines, programs, and/or data structures that perform particular tasks and/or implement particular abstract data types. In some embodiments, the modules can be implemented as computing services. For example, a module can be considered a service with one or more processes executing on a server or other computer hardware. Such services can provide a service application that receives requests and provides output to other services or consumer devices. An API can be provided for each module to enable a first module to send requests to and receive output from a second module. Such APIs can also allow third parties to interface with the module and make requests and receive output from the modules. When firmware is used, the operations performed by the components can be implemented in program instructions and data and stored in persistent memory to run on a processor unit. When hardware is employed, the hardware can include circuits that operate to perform the operations of the components described above.

A network (not shown) can be provided to enable communication between the components of the computational environment 100. The network can include any useful computing network, including an intranet, the Internet, a local area network, a wide area network, a wireless data network, or any other such network or combination thereof. Components utilized for the network can depend at least in part upon the type of network and/or environment selected. Communication over the network can be enabled by wired or wireless connections and combinations thereof. While FIG. 1 illustrates an example of a computational environment that can implement the techniques above, many other similar or different environments are possible. The example environments discussed and illustrated above are merely representative and not limiting.

The term “datastore” and other information storage components relevant to operation and functionality of a component of the computational environment 100 are utilized to refer to memory components. Memory components described herein can be either volatile memory or nonvolatile memory or can include both volatile and nonvolatile memory.

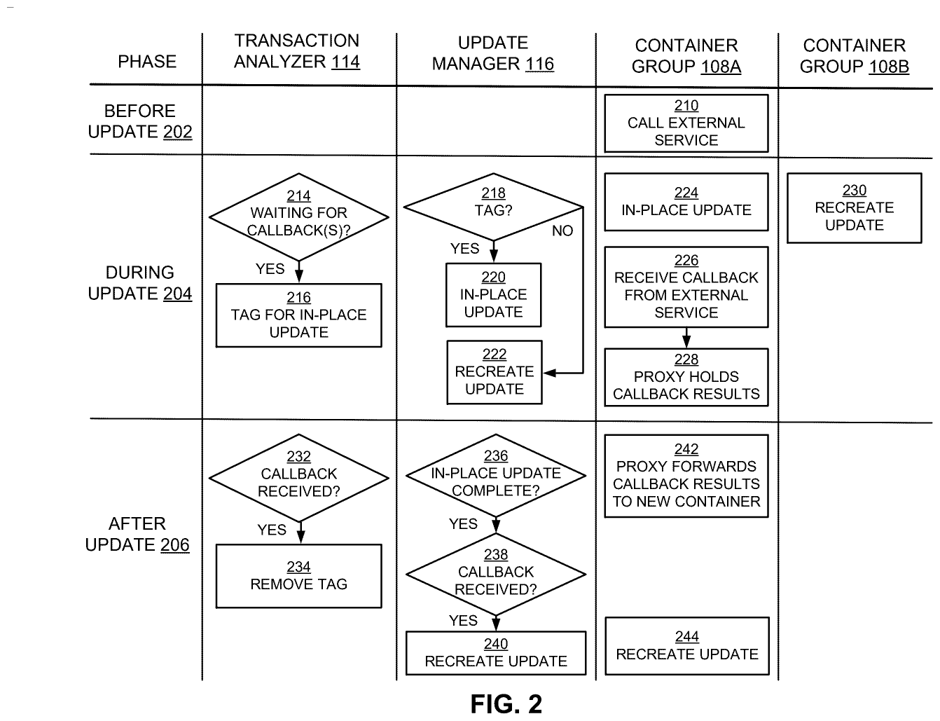

With continued reference to FIG. 1, FIG. 2 is a diagram illustrating aspects of updating a service 126A implemented by container groups 108A and 108B using a recreate update procedure and an in-place update procedure based on a status of a transaction between a container group 108A or 108B and an external service 106, in accordance with some embodiments of the present disclosure. More particularly, illustrated are the phases associated with performing the updates of container groups 108A and 108B and the methods performed during the various phases. As will be appreciated, although two container groups 108A and 108B are illustrated, any number of container groups may be involved in an update of service 126A.

Prior to an update 202, in operation 210, container group 108A initiates a transaction by calling external service 106. As described earlier, the service 126A implemented by container groups 108A and 108B can make calls to external services 106. Calls, in some embodiments, can comprise a callback function that passes a function as an argument to another function performed by an external service 106. The external service 106 performs the function and then sends a callback to proxy 130, which forwards the information in the callback to the container group 108.

After container group 108A initiating the transaction with external service 106, but prior to receiving a callback from external service 106, update manager 116 receives a command to update service 126A. For example, an administrator, or another appropriate user, may send an update command to update manager 116 instructing update manager 116 to update the container groups 108A and 108B that implement service 126A using a container image that includes updated application code.

During the update 204, and as part of receiving the update command, update manager 116 sends a request to transaction analyzer 114 to identify container groups 108 that have ongoing transactions with an external service 106. In operation 214, in response to the request, transaction analyzer 114 ascertains whether container groups 108A and 108B have ongoing transactions with an external service 106. As described earlier, transaction analyzer 114 can monitor transaction logs of container groups 108A and 108B to identify incomplete transactions and assign the in-place update tag described earlier to a container group 108 identified as having an incomplete transaction. The in-place update tag indicates to update manager 116 that, in the event that an update command is received, perform the in-place update operation.

In operation 216, responsive to a determination that container group 108A has an ongoing transaction with external service 106 (e.g., container group 108A is waiting for a callback from external service 106), transaction analyzer 114 assigns the in-place update tag to container group 108A. That is, transaction analyzer 114 adds the in-place update tag to metadata for container group 108A, where the metadata may be stored in datastore 120.

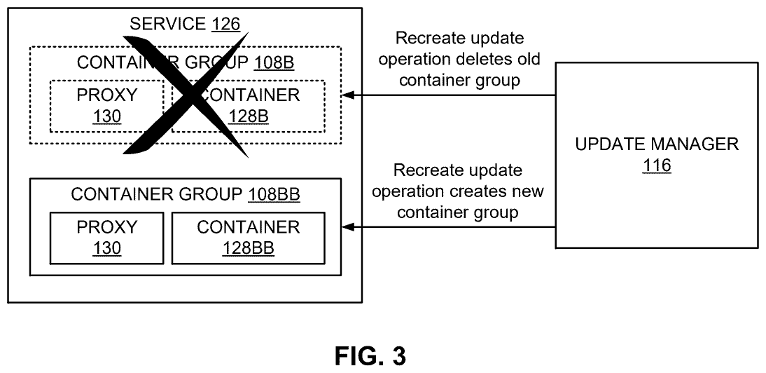

In operation 218, update manager 116 determines whether any of container groups 108A and 108B are assigned the in-place update tag. Illustratively, update manager 116 queries metadata (located in datastore 120) for container groups 108A and 108B to determine whether the metadata includes the in-place update tag. In this illustrative example, update manager 116 determines that container group 108B is not assigned the in-place update tag, and therefore, update manager 116 initiates the recreate update operation, as in operation 222. Accordingly, in operation 230, the recreate update operation is performed. As illustrated in FIG. 3, the recreate update operation deletes container group 108B and container 128B and creates a replacement container group 108BB and container 128BB using an updated container image (e.g., a container image that includes a new version of application code). In some embodiments, the recreate update operation also deletes the instance of proxy 130 included in container group 108B and creates a new instance of proxy 130 for inclusion in replacement container group 108BB.

Returning to FIG. 2 and operation 218, update manager 116 determines that container group 108A is assigned the in-place update tag, and therefore, update manager 116 initiates the in-place update operation, as in operation 220. Accordingly, in operation 224, the in-place update operation is performed.

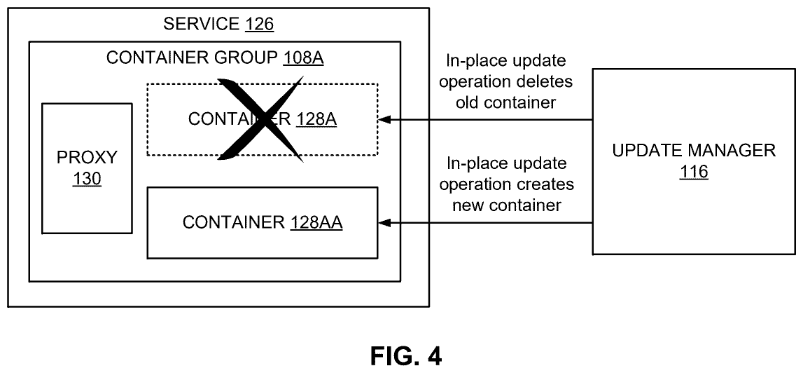

As illustrated in FIG. 4, the in-place update operation deletes container 128A, but does not delete container group 108A. The in-place update operation then replaces container 128A with container 128AA using the updated container image (e.g., the same updated container image used for the recreate update operation above). As part of initiating the in-place update operation, update manager 116 instructs proxy 130, that in the event that external service 106 returns the callback of the transaction initiated from container group 108A prior to starting the update of service 126A, proxy 130 is to hold the callback in memory. Accordingly, during the update 204, in operation 226, proxy 130 receives the callback from external service 106, and in operation 228, proxy 130 holds the callback in memory to allow the callback to be provided to new container 128AA created by the in-place update operation. After the update 206, update manager 116, in operation 236, determines that the in-place update operation has completed. As part of determining that the in-place update operation has completed, update manager 116 removes the hold on proxy 130, and in operation 242, proxy 130 forwards the callback to new container 128AA.

Returning again to FIG. 2, in operation 232, transaction analyzer 114 determines that the callback of the transaction with the external service 106 have been returned. Responsive to this determination, in operation 234, transaction analyzer 114 removes the in-place update tag assigned to container group 108A.

Update manager 116, in operation 236, determines that the in-place update operation has completed (via state information available to update manager 116 from controller manager 112). Thereafter, in operation 238, update manager 116 determines whether the transaction with the external service 106 has been completed by, for example, checking whether the in-place update tag has been removed from container group 108A.

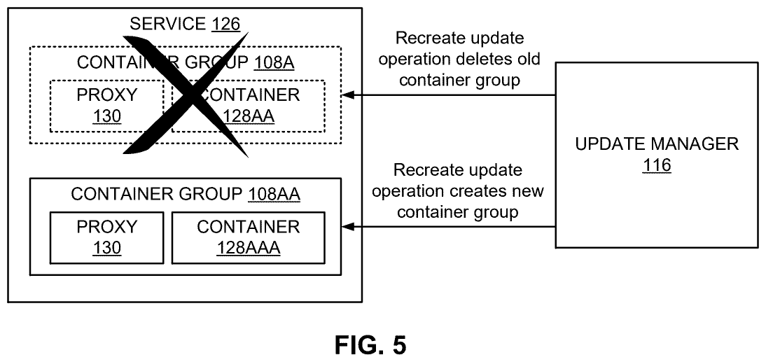

Responsive to a determination that the transaction is complete, update manager 116, in operation 240, initiates the recreate update operation. In operation 244, the recreate update operation is performed, which as shown in FIG. 5, deletes container group 108A (including the new container 128AA created by the in-place update operation) and creates a replacement container group 108AA and replacement container 128AAA, thereby allowing controller manager 112 to perform resource allocation. In the illustrative examples above, the same reference numeral may be used in more than one figure. This reuse of a reference numeral in different figures represents the same element in the different figures.

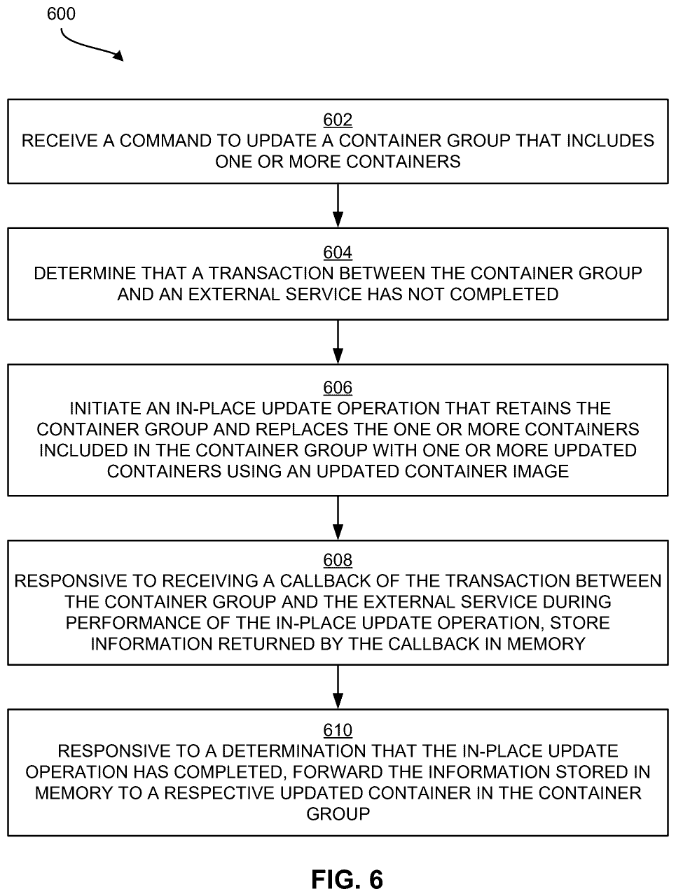

FIG. 6 is a flow diagram illustrating an example method 600 for updating container groups executing in a production environment, in accordance with some embodiments of the present disclosure. A production environment, or a deployment environment, refers to a computational environment in which current versions of containers that implement services (e.g., software programs, applications, websites, and the like) execute to make the services available to end-users. In some embodiments, updating a container group in a production environment using the method 600 can comprise updating one or more containers included in a container group with a minor software release, or can comprise upgrading one or more containers included in a container group with a major software release.

In operation 602, the method 600 receives a command to update a container group. The container group includes one or more containers that share storage and network resources, and the one or more containers comprise executable units of software that package application code with libraries and dependencies for the application code.

In operation 604, the method 600 determines that a transaction between the container group and an external service has not completed. In some embodiments, responsive to receiving the command to update the container group, the method 600 analyzes a transaction log of the container group to determine whether an incomplete transaction exists between the container group and the external service. In some embodiments, the method 600 analyzes the transaction log by performing keyword searches of the transaction log for keywords that indicate that the container group has initiated a transaction that includes a callback with the external service, but has not yet received the callback from the external service.

In the case that the method 600 determines that an incomplete transaction exists between the container group and the external service, the method 600 can assign an in-place update tag to the container group. The in-place update tag indicates that the container group is to be updated using the in-place update operation. That is, instead of updating the container group using a recreate update operation that deletes the container group and associated containers, and then creates a new container group and associated containers using an updated container image, the in-place update operation is to be performed to allow the transaction between the container group and the external service to be completed.

In operation 606, the method 600 initiates an in-place update operation that retains the container group and replaces the one or more containers included in the container group with one or more updated containers using an updated container image. In some embodiments, responsive to receiving the command to update the container group, the method 600 checks for the in-place update tag and initiates performance of the in-place update operation when the in-place update tag is found, otherwise, the method 600 initiates performance of the recreate update operation. As described earlier, the in-place update operation replaces a container(s) included in the container group without deleting the container group (i.e., the container group object).

In operation 608, responsive to receiving a callback of the transaction between the container group and the external service during performance of the in-place update operation, the method 600 stores information returned by the callback in memory. In some embodiments, the method 600 intercepts the callback using a proxy. The proxy acts as an intermediary between the container(s) in the container group and the external service, such that network communications associated with transactions between container group and the external service are routed through the proxy. The proxy is further configured to hold the information returned by the callback in memory, and forward the information to a respective updated container in the container group after the in-place update operation has completed. For example, as part of initiating performance of the in-place update operation, the method 600 instructs the proxy, that in the event that the callback is received during performance of the in-place update operation, hold the information provided in the callback in memory to allow the information to be forwarded to the container group after completion of the in-place update operation.

In operation 610, responsive to a determination that the in-place update operation has completed, the method 600 forwards the information stored in memory to the container group that has been updated using the in-place update operation. In some embodiments, the method 600 monitors the container group to determine when the in-place update operation has completed, and in response to detecting that the in-place update operation is complete, the method 600 forwards the information stored in memory to the updated container group. In some embodiments, the method 600 executes as part of a control plane that has access to state information of a cluster on which the container group is hosted, and the method 600 can monitor the state information to detect when the in-place update operation has completed.

In response to detecting that the in-place update operation is complete, the method 600 can instruct the proxy to remove the hold on the callback, thereby allowing the proxy to forward the information to the updated container group. The updated container group can then complete the transaction using the information provided in the callback. Also, in some embodiments, responsive to detecting that the in-place update operation has completed, the method 600 can remove the in-place update tag from the container group, thereby allowing the recreate update operation to be performed on the container group, as described below.

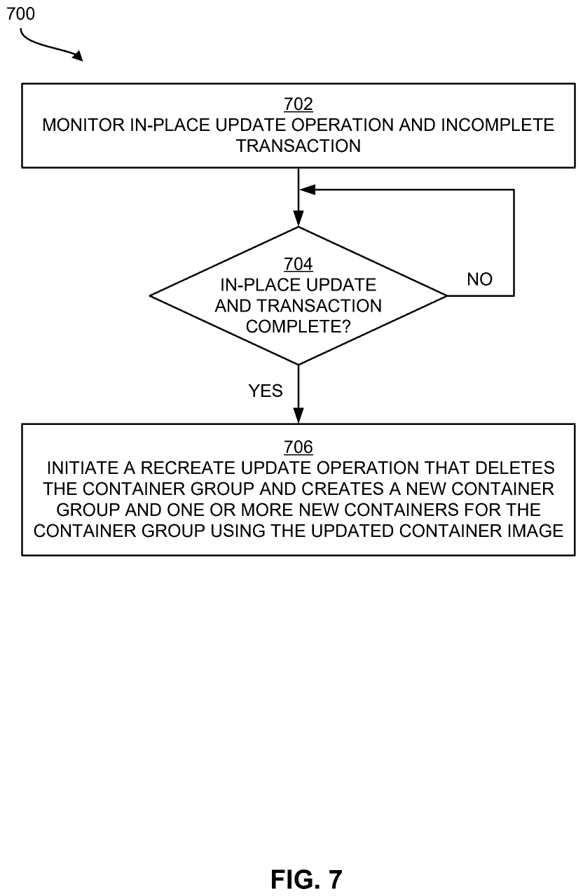

FIG. 7 is a flow diagram illustrating an example method 700 for recreating a container group after determining that an in-place update operation and a transaction that was initiated prior to receiving an update command has completed, in accordance with some embodiments of the present disclosure. As explained earlier, because the in-place update operation does not delete the container group, the container group retains the same container group resource configuration, which over time can lead to resource allocation issues, including load balancing issues. To avoid this, the method 700 can be performed to delete the container group (including any containers included in the container group) and recreate the container group after both the in-place update operation has completed and any transactions initiated prior to the in-place update operation have completed.

Accordingly, after initiating an in-place update operation for a container group, the method 700, in operation 702, monitors the in-place update operation and monitors one or more transactions that were incomplete at the time that the in-place update operation was initiated. As mentioned earlier, in some embodiments, the method 700 executes as part of a control plane that has access to state information of a cluster on which the container group is hosted, and the method 700 can monitor the state information to detect when the in-place update operation has completed and remove the in-place update tag from the container group. Moreover, the method 700 can monitor a transaction log for the container group to determine when an incomplete transaction between the container group and an external service completes.

In operation 704, the method 700 determines whether both the in-place update operation and the transaction have completed. In some embodiments, the method 700 checks whether the in-place update tag has been removed from the container group, which indicates to the method 700 that the in-place update operation is complete. In some embodiments, the method 700 monitors the state information associated with the container group to detect when the in-place update operation has completed. If the method 700 determines that the in-place update operation has completed, the method 700 can query the transaction log for the container group to determine whether the transaction between the container group and the external service has finished.

After determining that both the in-place update operation and the transaction have completed, the method 700, in operation 706, initiates a recreate update operation that deletes the container group (including any containers included in the container group) and creates a new container group and one or more new containers for the container group using an updated container image. The updated container image can be the same container image used by the in-place update operation, or the updated container image can be a subsequent version that was released between performance of the in-place update operation and the recreate update operation. Performing the recreate update operation allows resource allocation to be performed, which avoids the resource allocation issues associated with performing just the in-place update operation.

The methods 600 and 700 described above can be performed by a computer, performed in a cloud environment (e.g., clouds 805 or 806 in FIG. 8), and/or generally can be implemented in fixed-functionality hardware, configurable logic, logic instructions, etc., or any combination thereof. In some alternative implementations of an illustrative embodiment, the operations (or functions) noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in the flowcharts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, a computer-readable storage media or medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media or medium, as the terms are used in the present disclosure, are not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 800 contains an example of an environment for the execution of at least some of the computer code involved in performing the disclosed methods, such as block 850 containing computer code for update manager 116, transaction analyzer 114, and the other components described earlier. In addition to block 850, computing environment 800 includes, for example, computer 801, wide area network (WAN) 802, end-user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer-readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as cache 821 and the other storage media discussed below. The computer-readable program instructions, and associated data, are accessed by processor set 810 to control and direct performance of the disclosed methods. In computing environment 800, at least some of the instructions for performing the disclosed methods may be stored in block 850 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open-source Portable Operating System Interface type operating systems that employ a kernel. The code included in block 850 typically includes at least some of the computer code involved in performing the disclosed methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer-readable program instructions for performing the disclosed methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END-USER DEVICE (EUD) 803 is any computer system that is used and controlled by an end-user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end-user, this recommendation would typically be communicated from network module 815 of computer 801 through WAN 802 to EUD 803. In this way, EUD 803 can display, or otherwise present, the recommendation to an end-user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

It will be further appreciated that various aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A computer-implemented method comprising:
receiving a command to update a container group, wherein the container group includes one or more containers that share storage and network resources, and the one or more containers comprise executable units of software that package application code with libraries and dependencies for the application code;
determining that a transaction between the container group and an external service has not completed;
initiating an in-place update operation that retains the container group and replaces the one or more containers included in the container group with one or more updated containers using an updated container image;
responsive to receiving a callback of the transaction between the container group and the external service during performance of the in-place update operation, storing information returned by the callback in memory; and
responsive to a determination that the in-place update operation has completed, providing the information stored in the memory to the container group that includes the one or more updated containers.

2. The computer-implemented method of claim 1, further comprising:
responsive to determining that the in-place update operation and the transaction between the container group and the external service have completed, initiating a recreate update operation that deletes the container group and the one or more updated containers and creates a new container group and one or more new containers using the updated container image.

3. The computer-implemented method of claim 2, further comprising:
monitoring a transaction log of the container group to determine that the in-place update operation and the transaction between the container group and the external service have completed.

4. The computer-implemented method of claim 1, wherein determining that the transaction between the container group and the external service has not completed further comprises:
analyzing a transaction log of the container group to identify incomplete transactions that include a callback.

5. The computer-implemented method of claim 4, further comprising:
assigning an in-place update tag to the container group, wherein the in-place update tag indicates that, alternative to performing a recreate update operation that deletes the container group and creates a new container group, the in-place update operation is to be performed to allow the transaction between the container group and the external service to be completed.

6. The computer-implemented method of claim 1, further comprising:
intercepting the callback using a proxy, wherein the proxy holds the information returned by the callback in memory and forwards the information to a respective updated container in the container group after the in-place update operation has completed.

7. The computer-implemented method of claim 6, further comprising:
monitoring a transaction log of the container group to determine that the in-place update operation has completed; and
instructing the proxy to forward the information to the respective updated container in the container group.

8. A computer system comprising:
a processor set;
one or more computer-readable storage media; and
program instructions stored on the one or more computer-readable storage media to cause the processor set to perform operations comprising:
receiving a command to update a container group, wherein the container group includes one or more containers that share storage and network resources, and the one or more containers comprise executable units of software that package application code with libraries and dependencies for the application code;
determining that a transaction between the container group and an external service has not completed;
initiating an in-place update operation that retains the container group and replaces the one or more containers included in the container group with one or more updated containers using an updated container image;
responsive to receiving a callback of the transaction between the container group and the external service, storing information returned by the callback in memory; and
responsive to a determination that the in-place update operation has completed, providing the information stored in the memory to the container group that includes the one or more updated containers.

9. The computer system of claim 8, wherein the program instructions further cause the processor set to perform operations comprising:
responsive to determining that the in-place update operation and the transaction between the container group and the external service have completed, initiating a recreate update operation that deletes the container group and the one or more updated containers and creates a new container group and one or more new containers using the updated container image.

10. The computer system of claim 9, wherein the program instructions further cause the processor set to perform operations comprising:
monitoring a transaction log of the container group to determine that the in-place update operation and the transaction between the container group and the external service have completed.

11. The computer system of claim 8, wherein determining that the transaction between the container group and the external service has not completed further comprises:
analyzing a transaction log of the container group to identify incomplete transactions that include a callback.

12. The computer system of claim 8, wherein the program instructions further cause the processor set to perform operations comprising:
assigning an in-place update tag to the container group, wherein the in-place update tag indicates that, alternative to performing a recreate update operation that deletes the container group and creates a new container group, the in-place update operation is to be performed to allow the transaction between the container group and the external service to be completed.

13. The computer system of claim 8, wherein the program instructions further cause the processor set to perform operations comprising:
intercepting the callback using a proxy, wherein the proxy holds the information returned by the callback in memory and forwards the information to a respective updated container in the container group after the in-place update operation has completed.

14. The computer system of claim 13, wherein the program instructions further cause the processor set to perform operations comprising:
monitoring a transaction log of the container group to determine that the in-place update operation has completed; and
instructing the proxy to forward the information to the respective updated container in the container group.

15. A computer program product comprising:
one or more computer-readable storage media; and
program instructions stored on the one or more computer-readable storage media to perform operations comprising:
receiving a command to update a container group, wherein the container group includes one or more containers that share storage and network resources, and the one or more containers comprise executable units of software that package application code with libraries and dependencies for the application code;
determining that a transaction between the container group and an external service has not completed;
initiating an in-place update operation that retains the container group and replaces the one or more containers included in the container group with one or more updated containers using an updated container image;
responsive to receiving a callback of the transaction between the container group and the external service, storing information returned by the callback in memory; and
responsive to a determination that the in-place update operation has completed, providing the information stored in the memory to the container group that includes the one or more updated containers.

16. The computer program product of claim 15, wherein the operations further comprise:
responsive to determining that the in-place update operation and the transaction between the container group and the external service have completed, initiating a recreate update operation that deletes the container group and the one or more updated containers and creates a new container group and one or more new containers using the updated container image.

17. The computer program product of claim 15, wherein determining that the transaction between the container group and the external service has not completed further comprises:
analyzing a transaction log of the container group to identify incomplete transactions that include a callback.

18. The computer program product of claim 15, wherein the operations further comprise:
assigning an in-place update tag to the container group, wherein the in-place update tag indicates that, alternative to performing a recreate update operation that deletes the container group and creates a new container group, the in-place update operation is to be performed to allow the transaction between the container group and the external service to be completed.

19. The computer program product of claim 15, wherein the operations further comprise:
intercepting the callback using a proxy, wherein the proxy holds the information returned by the callback in memory and forwards the information to a respective updated container in the container group after the in-place update operation has completed.

20. The computer program product of claim 19, wherein the operations further comprise:
monitoring a transaction log of the container group to determine that the in-place update operation has completed; and
instructing the proxy to forward the information to the respective updated container in the container group.
